(19) United States
(12) Patent Application Publication
(10) Pub. No.: US 2025/0356337 A1
(43) Pub. Date: Nov. 20, 2025

(54) METHOD FOR SUPPORTING NFC PAYMENTS AND AUTHENTICATION, AND DEVICE THEREFOR

(71) Applicant: TOUCHNGO CO., Seoul (KR)

(72) Inventor: Jeong Ho CHA, Seoul (KR)

(21) Appl. No.: 18/872,317

(22) PCT Filed: Jun. 21, 2023
(86) PCT No.: PCT/KR2023/008600

§ 371 Date: Dec. 6, 2024

(30) Foreign Application Priority Data
Jun. 21, 2022 (KR) 10-2022-0075875
Jan. 31, 2023 (KR) 10-2023-0012376

(51) Int. Cl. G06Q 20/32

(52) U.S. Cl. CPC G06Q 20/3278; G06Q 2220/00

(57) ABSTRACT

The present disclosure relates to a method of supporting near field communication (NFC) payment for a user terminal, and a device configured to perform the method. More particularly, the present disclosure relates to a method of providing an environment in which NFC payment may be performed by actively utilizing an NFC writing function of a user terminal to enable the NFC payment for the user terminal when the user terminal does not support a card mode during the NFC payment, and a device configured to perform the method.

### BACKGROUND OF THE INVENTION

### Field of the Invention

The present disclosure relates to a method of supporting near field communication (NFC) payment and authentication for a user terminal, and a device configured to perform the method, and more particularly, to a method of providing an environment in which NFC payment may be performed by actively utilizing an NFC writing function of a user terminal to enable NFC payment and authentication for the user terminal when the user terminal does not support a card mode during the NFC payment, and a device configured to perform the method. In addition, the present disclosure relates to an NFC payment support method that allows NFC payment for both a payment element configured to function in a read/write mode and a payment element configured to function in a card mode during an attempt to perform the NFC payment using a user terminal or an NFC card, and a device configured to perform the NFC payment support method.

### Background of the Related Art

Owing to rapid development of technology related to user terminals (smartphones) and network infrastructure that enables ultra-high speed communication, payments using user terminals have now become widely used. Particularly, a magnetic secure transmission (MST)-based payment function supported by Android operating system (OS)-based user terminals manufactured by Company S has been well-received by many users for convenient usability, and a number of Android OS users have been significant increased due to simplicity and convenience of this payment function.

On the other hand, although on iPhone operating system (IOS)-based user terminals manufactured by Company A have built-in physical hardware to enable a near field communication (NFC)-based payment function, software restrictions that disable a card mode are present in many countries including Korea. Thus, user terminal-based payments cannot be virtually performed. In spite of a highest market share in a whole market for user terminals due to advantages such as an excellent product design and a user-friendly interface, since simple payment using a user terminal cannot be performed, many buyers hesitate to purchase Company A's user terminal.

The present disclosure is directed to solving the aforementioned problems and other drawbacks, and relates to a method and device that enable NFC payment even in a user environment in which use of a card mode is restricted, like the iOS-based user terminals manufactured by Company A.

### SUMMARY OF THE INVENTION

Therefore, the present disclosure has been made in view of the above problems, and it is an object of the present disclosure to enable near field communication (NFC) payment even when using a user terminal that may not perform simple payment due to a deactivation restriction on a card mode.

In addition, it is also an object of the present disclosure to enable payment with higher security by utilizing NFC technology to transmit information needed for payment (e.g., identification information of a card medium needed for payment, etc.), compared to a payment method of scanning a barcode or a quick response (QR) code or a payment method based on magnetic secure transmission (MST) technology.

In addition, it is also an object of the present disclosure to enable NFC payment for Company A's user terminals simply by further having, by a member store, a small device (an NFC payment support device) without replacing an existing payment terminal.

In addition, it is also an object of the present disclosure to simultaneously increase convenience of both users and member store owners by supporting NFC payment methods in various modes.

In addition, it is also an object of the present disclosure to allow to detect an NFC payment method and then activate a payment mode that matches a type of the NFC payment method so that an appropriate payment mode is activated automatically without having to perform any separate manipulation by a user or a member store owner.

Meanwhile, the present disclosure may, however, be embodied in many different forms and should not be construed as being limited to the embodiments set forth herein. Additional aspects will be set forth in part in the description which follows and, in part, will be apparent from the description, or may be learned by practice of the presented exemplary embodiments.

To accomplish the above object, according to one aspect of the present disclosure, there is provided a method of supporting near field communication (NFC) payment for a user terminal, the method including: writing medium identification information from the user terminal to an NFC tag module in an NFC payment support device; reading, by the NFC payment support device, a value written to the NFC tag module; and transmitting, by the NFC payment support device, the read value to a payment terminal.

In addition, the medium identification information written to the NFC payment support device may be medium identification information encrypted by the user terminal.

In addition, the method may further include: after the writing of the encrypted medium identification information to the NFC payment support device, decrypting, by the NFC payment support device, the encrypted medium identification information; and determining, by the NFC payment support device, whether the decrypted medium identification information is medium identification information for NFC payment.

According to another aspect of the present disclosure, there is provided a near field communication (NFC) payment support device configured to support NFC payment for a user terminal, the NFC payment support device including: an NFC tag module to which medium identification information from the user terminal is written by an NFC writing function of the user terminal; a control unit configured to read a value written to the NFC tag module and transmit the read value to a payment terminal via a port; a communication unit configured to support transception of data between the NFC payment support device and the payment terminal connected to the NFC payment support device via a network; and a power supply unit configured to supply power for driving the NFC payment support device.

In addition, the NFC payment support device may further include a microphone configured to detect a sound wave signal output from the user terminal, wherein the control unit converts the sound wave signal detected by the microphone into a signal transmittable to the payment terminal.

According to another aspect of the present disclosure, there is provided a method of supporting near field communication (NFC) payment by a user terminal, the method including: writing medium identification information from the user terminal to an NFC tag module in an NFC payment terminal; reading, by the NFC payment terminal, a value written to the NFC tag module; and generating, by the NFC payment terminal, payment information, wherein the payment information is payment information of a product or a service that a user of the user terminal is to purchase; and transmitting, by the NFC payment terminal, the read value, and the payment information to a financial company server, wherein the read value is identical to the medium identification information.

In addition, according to another aspect of the present disclosure, there is provided a near field communication (NFC) payment terminal configured to support NFC payment for a user terminal, the NFC payment terminal including: an NFC tag module to which medium identification information from the user terminal is written by an NFC writing function of the user terminal; a control unit configured to read a value written to the NFC tag module, generate payment information, and transmit the read value and the payment information to a financial company server, wherein the payment information is payment information of a product or a service that a user of the user terminal is to purchase and the read value is identical to the medium identification information; a communication unit configured to support transception of data between the NFC payment terminal and the financial company server connected to the NFC payment terminal via a network; and a power supply unit configured to supply power for driving the NFC payment terminal.

According to the present disclosure, an effect of enabling simple payment using user terminals that could not substantially perform simple payment and, particularly, greatly increasing convenience of users of, particularly, iPhone operating system (IOS)-based user terminals may be obtained.

In addition, according to the present disclosure, an effect of increasing payment efficiency without a cost burden by increasing a usage rate of NFC-based simple payment while utilizing infrastructure provided in existing member stores may be obtained.

In addition, according to the present disclosure, an effect of helping users and member stores to feel safe when using a payment service may be obtained by providing a service relatively safe from security threats such as information theft that may occur in other payment methods.

Effects of the present disclosure are not limited to those described above, and other technical effects will be clearly understood by those skilled in the art from the following description.

### BRIEF DESCRIPTION OF THE DRAWINGS

FIG. 1 is a diagram sequentially illustrating a payment flow when a near field communication (NFC) payment support method according to the present disclosure is used.

FIG. 2 is a diagram sequentially illustrating an NFC payment support method according to a first embodiment of the present disclosure.

FIGS. 3 and 4 are diagrams illustrating a configuration of an NFC payment support device according to the present disclosure.

FIG. 5 is a diagram illustrating an NFC payment support method according to a second embodiment of the present disclosure.

FIG. 6 is a diagram illustrating an NFC payment support method according to a third embodiment of the present disclosure.

FIG. 7 illustrates a process of implementing an application function by utilizing an NFC support device without being limited to a payment field.

FIG. 8 is a diagram illustrating an NFC payment support method according to a fourth embodiment of the present disclosure.

FIG. 9 is a diagram sequentially illustrating a multi-mode NFC payment support method according to a fifth embodiment of the present disclosure.

FIG. 10 is a diagram illustrating components of a multi-mode NFC payment support device.

FIG. 11 is a diagram illustrating a multi-mode NFC payment support method according to a fifth-first embodiment of the present disclosure.

FIGS. 12 and 13 are diagrams illustrating a multi-mode NFC payment support method according to a fifth-second embodiment of the present disclosure.

FIG. 14 is a flowchart illustrating a multi-mode NFC payment support method according to a fifth-second embodiment.

### DETAILED DESCRIPTION OF THE PREFERRED EMBODIMENT

Objectives and technical features of the present disclosure, and operational effects thereof will become apparent from the following detailed description provided with reference to the accompanying drawings. Hereinafter, an embodiment of the present disclosure will be described in detail with reference to the accompanying drawings.

Embodiments disclosed herein should not be construed or utilized to limit the scope of the present disclosure. It will be apparent to those skilled in the art that the description of the embodiments described herein will have a variety of applications. Accordingly, any embodiment described in the detailed description of the present disclosure is only an example for better explaining the present disclosure and do not limit the scope of the present disclosure.

The functional blocks shown in the drawings and described herein are only examples of possible implementations. In other implementations, other functional blocks may be used without departing from the spirit and scope of the detailed description. Additionally, although one or more of the functional blocks in the present disclosure are represented as individual blocks, one or more of the functional blocks in the present disclosure may be a combination of various hardware and software configurations for performing the same function.

Additionally, an expression “including certain components” is an “open-type” expression, which simply indicates the presence of those components and should not be construed as excluding additional components.

It will be understood that when an element is referred to as being “connected with” or “coupled to” another element, the element may be directly connected with or coupled to the another element or intervening elements may also be present therebetween.

Hereinafter, respective embodiments of the present disclosure will be described in detail with reference to the accompanying drawings.

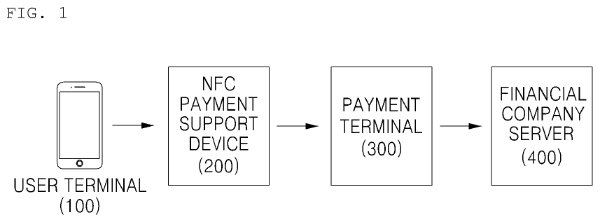

FIG. 1 is a schematic diagram illustrating an entire payment flow when a user terminal 100 uses a near field communication (NFC) payment support method and device presented in the present disclosure.

Referring to FIG. 1, the user terminal 100 may access an NFC payment support device 200 to transmit, to the NFC payment support device 200, information needed for payment, particularly, information such that a payment medium (a card number, or a one-time code capable of replacing the card number, hereinafter referred to as medium identification information) may be identified. Then, the NFC payment support device 200 transmits the received information to a payment terminal 300 equipped at a member store. The payment terminal 300 adds the medium identification information to actual product or service payment information of a user and requests an approval from a financial company server 400.

It may be particularly noted that medium identification information is recorded to the NFC payment support device 200 present between the user terminal 100 and the payment terminal 300 using an NFC writing function of the user terminal 100, and the NFC payment support device 200 transmits written medium identification information to the payment terminal 300 so that most important information needed for simple payment resultantly reaches the payment terminal 300.

An iPhone operating system (IOS)-based terminal of Company A is introduced as the user terminal 100 described herein. The user terminal 100 is equipped with a module capable of NFC write and read functions in terms of hardware, but activation in a card mode is restricted by software, and thus, a simple payment provided separately by Company A cannot be performed. However, with respect to the NFC payment support method and device according to the present disclosure, an NFC-based simple payment may be performed at any member store even by using the user terminal 100 having the above-described restriction.

For reference, each entity shown in FIG. 1 may be understood in terms of hardware as described below.

The user terminal 100 refers to a device possessed or carried by any user, and may include a portable terminal such as a smartphone, a personal digital assistant (PDA), a tablet PC, etc. It is assumed that such user terminals 100 are equipped with a central processing unit (CPU) and a memory. For reference, in the detailed description, it is supposed that the user terminal 300 is a smartphone, and more particularly, an iOS-based smartphone of Company A to help understanding of the present disclosure. In this case, the user terminal 100 may include a display and a touch-sensitive surface and, In some cases, may be further connected to one or more other physical user input elements such as a physical keyboard, a mouse, and/or a joystick. Additionally, the user terminal 100 may further include an element capable of detecting and recording sound or voice. Meanwhile, various applications executed on the user terminal 100 may optionally use at least one universal physical element for a user input such as a touch-sensitive surface. One or more functions of the touch-sensitive surface as well as corresponding information displayed on a terminal may optionally be adjusted or changed from one application to another application and/or within an individual application. By using this method, a universal physical architecture (such as a touch-sensitive surface) of a device may optionally support various applications using user interfaces intuitive and clear to users.

Then, it is assumed that the payment terminal 300 may be preferably a device capable of performing calculations and having a CPU and a memory. The CPU may also be referred to as a controller, a microcontroller, a microprocessor, or a microcomputer. In addition, the CPU may be implemented as hardware, firmware, software, or a combination thereof. In a case of using hardware, the CPU may be implemented as application specific integrated circuit (ASIC), a digital signal processor (DSP), a digital signal processing device (DSPD), a programmable logic device (PLD), a field programmable gate array (FPGA), etc. In a case of implementation using firmware or software, the firmware or software may be configured to include modules, procedures, or functions that perform the functions or operations described above. Additionally, the memory may be implemented as a read only memory (ROM), a random access memory (RAM), an erasable programmable read only memory (EPROM), an electrically erasable programmable read-only memory (EEPROM), a flash memory, a static RAM (SRAM), a hard disk drive (HDD), a solid state drive (SSD), etc. The payment terminals 300 may include all types of devices capable of receiving medium identification information (card information, a one-time code, etc.) from a purchaser, and then, requesting a payment approval from the financial company server 400 or a financial institution in an equivalent position, such as a point-of-sale (POS) terminal or a concatenate (CAT) terminal.

The financial company server 400 may literally mean a server computer of a company that manages a financial business, and may be implemented as a computing device equipped with the central processing unit and the memory mentioned above.

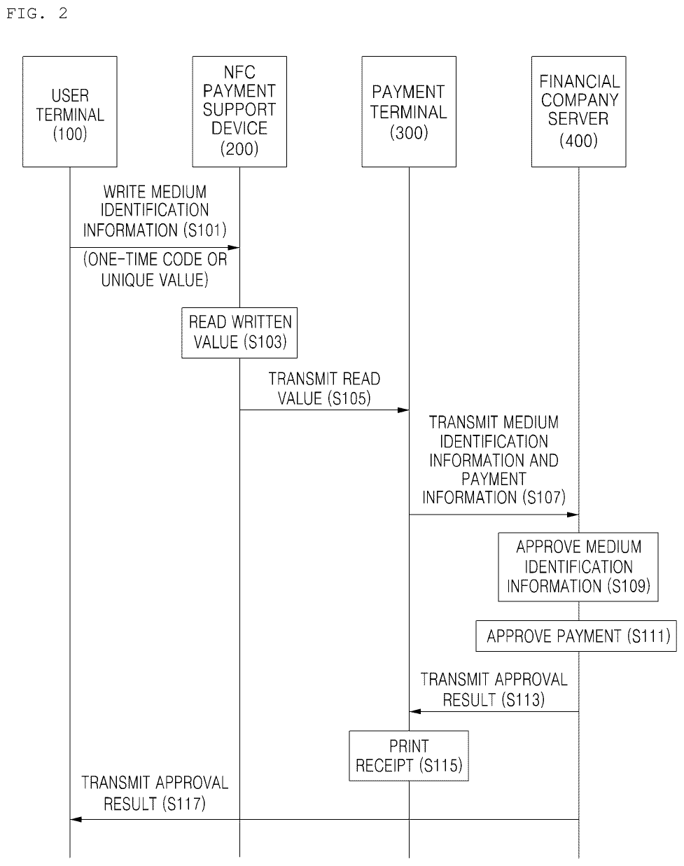

Hereinafter, an NFC payment support method according to a first embodiment of the present disclosure will be described with reference to FIG. 2.

Referring to FIG. 2, the NFC payment support method may include writing, by the user terminal 100, medium identification information to the NFC payment support device 200 (S101). This operation assumes that an NFC function of the user terminal 100 may be used, and further assumes that an NFC mode of the user terminal 100 is a mode in which NFC writing may be performed, such as a peer-to-peer (P2P) mode or a read/write mode. Additionally, the medium identification information may include information of a particular medium needed to make a payment, e.g., card information (a card number), a one-time value (code), or other unique values (codes). As a simple example, when a payment application is executed on the user terminal 100 to perform a simple payment, a one-time code (a barcode, a quick response (QR) code, etc.) with a limited time may be displayed on a screen. A one-time code generated using this method may be a type of medium identification information. However, medium identification information in the present disclosure is not displayed in a form of a barcode or a QR code as mentioned above, i.e., in a form displayed on a screen, and may be present only for a purpose of performing NFC writing to the NFC payment support device 200. Only a message indicating that an NFC write mode is ready or a message requesting NFC payment may be displayed on a screen of the user terminal 100, and a form that may be stolen or shared outside by taking a photograph (including scanning) such as a barcode, a QR code, or physical card information is not displayed on the screen. In addition, since operation S101 may be performed only when a user brings the user terminal 100 to be close to the NFC payment support device 200, it may be understood that this method is safer than other types of payment methods that allow payment from a long distance.

After operation S101, the NFC payment support device 200 reads the medium identification information written thereto, and transmits a read value, i.e., the read medium identification information to the payment terminal 300 (S103 and S105). Although described as being divided into two operations, operations S103 and S105 described above may be performed simultaneously during actual implementation. For example, in operation S101, when the user brings the user terminal 100 of the user to access the NFC payment support device 200, the medium identification information may be simultaneously written to and read by the NFC payment support device 200 and displayed on the screen of the payment terminal 300.

Meanwhile, when performing operation S105, the payment terminal 300 may not need to perform a prior preparation operation such as separately transmitting a ready state to the NFC payment support device 200. Preferably, control unit 203 may be programmed so that the NFC payment support device 200 transmits a value to the payment terminal 300 immediately after reading the value.

Alternatively, on the contrary to the description above, operation S105 may be implemented to be performed only when a ready state is confirmed by the payment terminal 300. That is, the payment terminal 300 may be a terminal capable of performing various payment methods. When a particular procedure or mode conversion is needed to accept NFC payment, the payment terminal 300 may finish the particular procedure or mode conversion, and then, notify the NFC payment support device 200 to transmit a read value.

After operation S105, the payment terminal 300 may transmit the received medium identification information together with payment information generated by the payment terminal 300 to the financial company server 400 (S107). The payment information means information about a purchase when a user wants to purchase a product or service in a particular member store, and may include, for example, a price, quantity, a name, transaction date and time, or a transaction location, a name of a person in charge who is involved in a transaction, or a name of a representative of the member store, with respect to a product or service to be transacted.

After operation S107, the financial company server 400 may approve the medium identification information received from the payment terminal 300 (S109), and approve payment (S111). In addition, the financial company server 400 may transmit a result of the approving to at least one of the payment terminal 300 and the user terminal 100 (operations S113 and S117).

It may be understood that the approving of the medium identification information (S109) includes checking whether identification information (a card, a one-time code, etc.) of a medium issued by the financial company server 400 is correct, and the approving of the payment (S111) includes a process of checking whether the received payment information does not include an abnormality, and whether any information containing an error is present.

Meanwhile, after receiving the result of the approving (S113), the payment terminal 300 may print a receipt as needed (S115).

The NFC payment support method according to the first embodiment of the present disclosure has been described above with reference to FIG. 2.

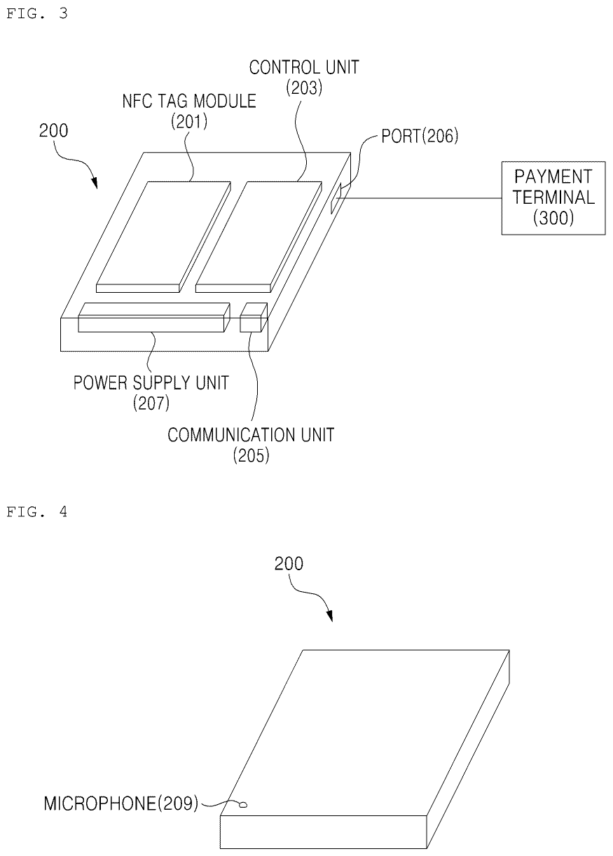

FIG. 3 illustrates a configuration of an NFC payment support device 200 described in the present disclosure.

Referring to FIG. 3, the NFC payment support device 200 may largely include an NFC tag module 201, the control unit 203, a communication unit 205, a port 206, and a power supply unit 207.

The NFC tag module 201 is configured such that medium identification information from the user terminal 100 is written thereto using an NFC writing function. The NFC tag module 201 may further include a loop line to receive power as needed. It may be understood that there is no limit in implementation of the NFC tag module 201 as long as any arbitrary information may be written by tagging operation using NFC technology currently available.

Then, the control unit 203 may function to control all components of the NFC payment support device 200, and particularly, may read a value written to the NFC tag module 201 by interoperating with the NFC tag module 201, and transmit the read value to the payment terminal 300 disposed outside through the port 206.

The communication unit 205 is configured to support transception of data between the NFC payment support device 200 and the payment terminal 300 via a network. The communication unit 205 may be understood as being configured to actually transmit the read value to the payment terminal 300 according to the control command of the control unit 203. The communication unit 205 may support wired/wireless communication. For example, when the payment terminal 300 is wired (using a serial cable, a USB cable, etc.), or when the payment terminal 300 is connected by Bluetooth (BLE) communication, infrared (IR) communication, WiFi, etc., the communication unit 205 supports data transception according to a corresponding communication method.

The power supply unit 207 is configured to supply all power needed to drive the NFC payment support device 200. The NFC payment support device 200 may be connected to the payment terminal 300 such as a point-of-sale (POS) terminal to receive necessary power. Alternately, the NFC payment support device 200 may be designed to receive power independently from a power outlet, or to receive power through a removable battery equipped therein, or to receive power through a charger.

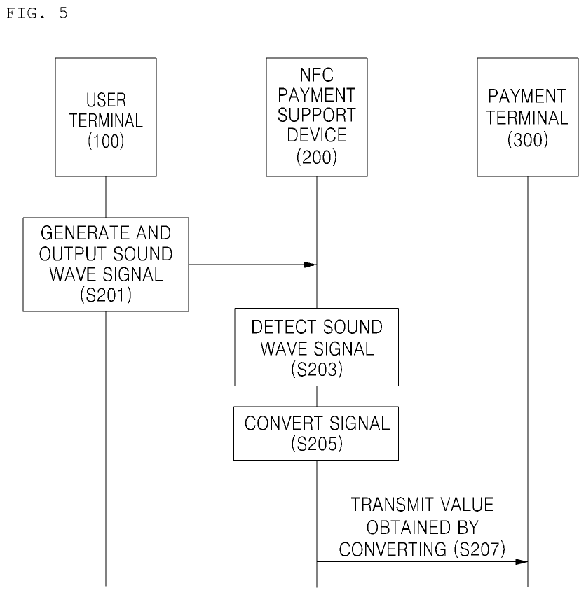

Meanwhile, FIG. 4 illustrates the NFC payment support device 200 needed to perform another payment support method in the present disclosure. The NFC payment support device 200 may further include a microphone 209 in addition to the components described above with reference to FIG. 3. The microphone 209 functions to detect a sound wave signal in an inaudible frequency band which is output from the user terminal 100. When the sound wave signal is detected by the microphone 209, the control unit 203 converts the sound wave signal and transmits the converted sound wave signal to the payment terminal 300. The converted sound wave signal may be in any format capable of being transmitted to outside, but may be desirably text data in a form of numbers, characters, or a combination thereof.

FIG. 5 illustrates an NFC payment support method according to a second embodiment to help understanding of the present disclosure. For reference, a process of detecting a sound wave signal and transmitting a converted value according to the second embodiment may be performed independently. However, since this detailed description assumes a situation of ‘NFC payment,’ it may be understood that the process of the detecting and the transmitting is also performed on an assumption of the NFC payment situation.

Referring to FIG. 5, the NFC payment support method according to the second embodiment may start with generating and outputting, by the user terminal 100, a sound wave signal (S201). The sound wave signal generally includes sound in a frequency band which humans cannot hear. For example, a card number or a one-time code may be generated in a form of a sound wave signal and then output through an output unit of the user terminal 100. At this time, the output unit of the user terminal 100 may be a speaker equipped in a smartphone, and any type of a built-in component capable of emitting sound may also function as the output unit.

After operation S201, the NFC payment support device 200 may detect the sound wave signal through the microphone 209 (S203) and immediately convert the detected sound wave signal (S205). As described above, the NFC payment support device 200 is a type of a computing device equipped with a CPU and a memory, and thus, may perform basic signal processing. In addition, since data transmitted on the sound wave signal (S203) is not generally complex data, the conversion of the sound wave signal may be performed using relatively a few resources.

After operation S205, the NFC payment support device 200 transmits a value obtained by the converting to the payment terminal 300 (S207).

From a perspective of the NFC payment support device 200, the second embodiment may be utilized for assisting or supplementing the NFC payment support method according to the first embodiment. For example, when an NFC payment on the user terminal 100 has been attempted but cannot be performed due to a malfunction in a component or an environmental issue, the user terminal 100 may proceed with payment by immediately generating and outputting a sound wave signal.

Alternatively, when NFC payment is attempted, the user terminal 100 may transmit, via a sound wave signal, another information, e.g., information for secondarily authenticating a user or information for authenticating whether corresponding medium identification information is appropriate for the NFC payment so that signal processing may be performed in parallel by the NFC payment support device 200. For example, the NFC payment support device 200, the payment terminal 300, or the financial company server 400 may be enabled to authenticate a user attempting to make a payment in two ways by allowing a card number to be written through an NFC function and writing personal identification number (PIN) information (a password, a pattern, etc.) preset by the user to be transmitted via a sound wave signal.

As such, the NFC payment support device 200 according to the present disclosure may enhance stability and security in payment by having a data transmission function using a sound wave signal as well as a data transmission function using an NFC function.

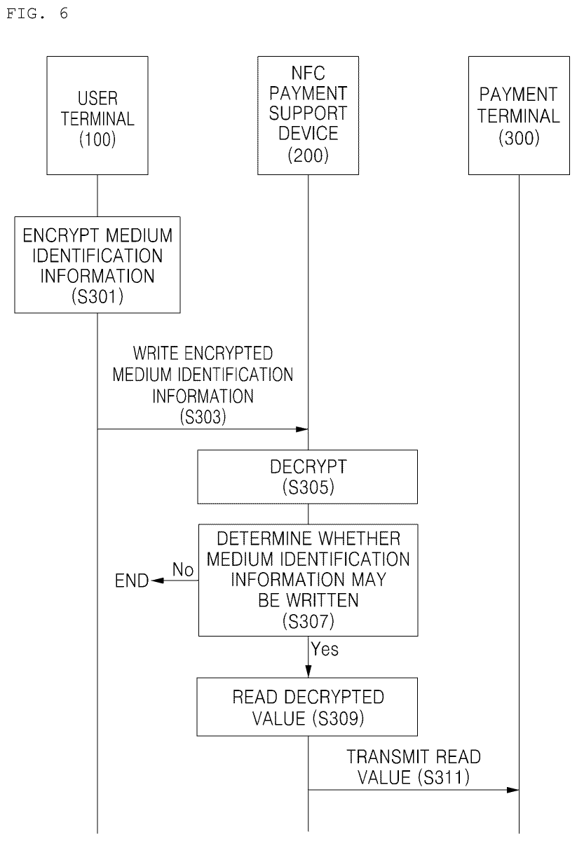

FIG. 6 is a diagram illustrating an NFC payment support method according to a third embodiment of the present disclosure. Compared to the first embodiment, the third embodiment is different from the first embodiment in that encrypted medium identification information is written.

Referring to FIG. 6, the NFC payment support method in the third embodiment includes encrypting medium identification information on the user terminal 100 (S301). As described above, the medium identification information refers to identification information of a medium (an element) needed to perform payment, and may include card information, a one-time code, etc. The user terminal 100 may further enhance data security by encrypting the medium identification information.

After operation S301, the user terminal 100 writes the encrypted medium identification information to the NFC payment support device 200, more precisely, the NFC tag module 201 (S303). The NFC payment support device 200 may attempt to decrypt the written medium identification information (S305). At this time, the NFC payment support device 200 may store and nave a decryption key shared or installed in advance.

After operation S305, the NFC payment support device 200 may determine whether written the medium identification information is medium identification information that may be written, in other words, medium identification information in a format appropriate for being used to perform the NFC payment (S307). For example, it may be determined, according to a separate determination algorithm, whether the medium identification information is appropriate for being written to perform the NFC payment, e.g., whether a specification for the decrypted medium identification information conforms to a standard format or whether the decrypted medium identification information is recorded in a blacklist.

When the medium identification information is determined as being inappropriate in operation S307, a procedure will be terminated. However, When the medium identification information is determined as being appropriate, the control unit 203 of the NFC payment support device 200 may read a decrypted value, i.e., the decrypted medium identification information and transmit the value to the payment terminal 300 (S311).

With reference to FIGS. 1 to 6, the NFC payment support methods according to the present disclosure and the NFC payment support device needed to perform the same have been described above.

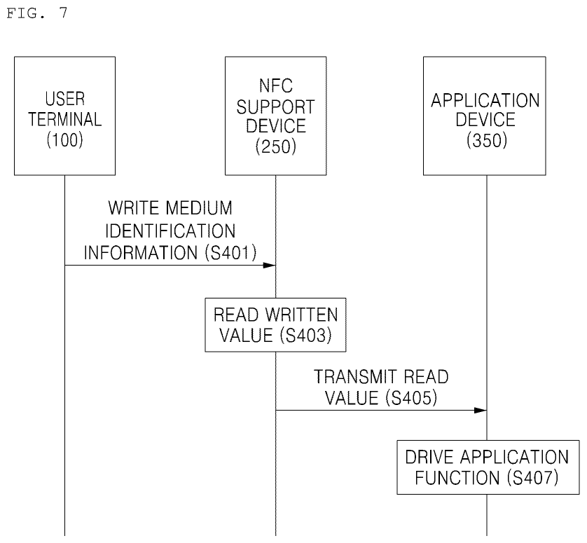

FIG. 7 illustrates an example of an NFC support method that is not limited to a payment field. This drawing generally illustrates a process of implementing an application function by utilizing an NFC support device 250.

All the embodiments described above assumes a ‘payment environment.’ However, an NFC support technology proposed herein may be variously utilized in environments other than an environment for payment. For example, an NFC support technology may be utilized in various fields, such as a process of identifying a user passing through a door, a process of opening a door lock of an apartment building, a process of verifying an identity at a bank, etc.

Referring to FIG. 7, the NFC support method may include writing, by a user terminal, an identification code to an NFC support device 250 (S401), reading a written value, i.e., the written identification code and transmitting the read value to an application device 350, the reading and the transmitting being performed by the NFC support device 250 (S403 and S405), and driving an application function by the application device 350 (S407). This may be understood with reference to the operations in a payment environment as described above. Thus, a detail description thereof will not be provided again here.

As a simple example to which FIG. 7 may be applied, in a process of opening a door lock of an apartment building, a user may place a smartphone of the user (a user terminal) in a write mode and access the NFC support device 250. Then, an identification code (a password or characters for opening the door lock) prestored in the smartphone may be written to the NFC support device 250. Then, the NFC support device 250 may unlock the door lock by transmitting the prestored identification code to the application device 350.

As such, the NFC support technology proposed herein enables various functions to be simply performed on the user terminal 100 that does not support a card mode.

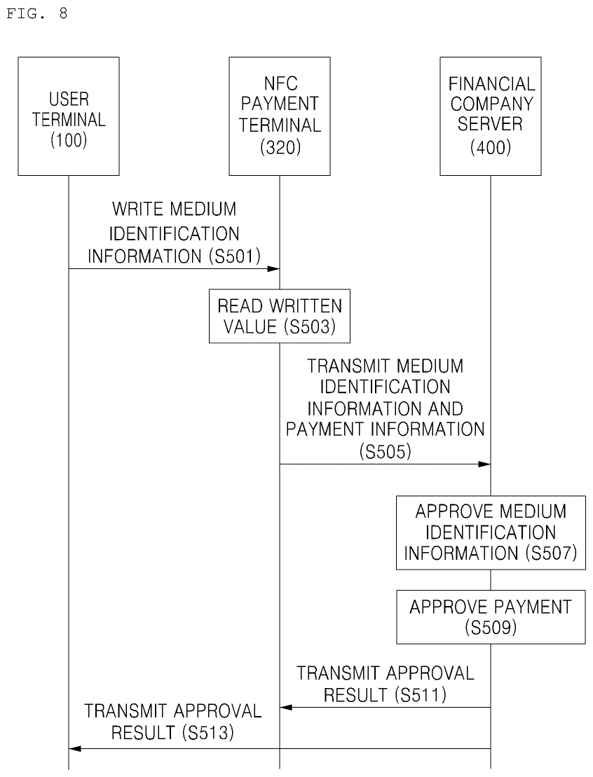

FIG. 8 is a diagram sequentially illustrating an NFC payment support method according to a fourth embodiment of the present disclosure.

The embodiments 1 to 3 are described above on an assumption of an environment in which the NFC payment support device 200 is separate from the payment terminal 300. The fourth embodiment is described on an assumption of an environment in which the NFC payment support device 200 and the payment terminal 300 are combined with each other. That is, an NFC payment terminal 320 described in the fourth embodiment means a device having a function of a payment terminal and also equipped with an NFC tag module therein to be capable of performing NFC writing.

Referring to FIG. 8, the NFC payment support method in the fourth embodiment starts with writing, by a user terminal 1000, medium identification information to the NFC payment support terminal 320 (S501).

After operation S501, the NFC payment terminal 320 reads a written value, i.e., the medium identification information written by the user terminal 100, and transmits the written value to the financial company server 400 together with payment information (S503 and S505).

After operation S505, the financial company server 400 goes through a process of approving the medium identification information and a process of approving payment (S507 and S509) using the same method as that in the previous embodiments, and then, transmits a result of the approval to at least one of the user terminal 100 and the NFC payment terminal 320 (S511 and S513).

Hereinafter, a multi-mode NFC payment support method and an NFC payment support device for performing the same according to another embodiment of the present disclosure are described.

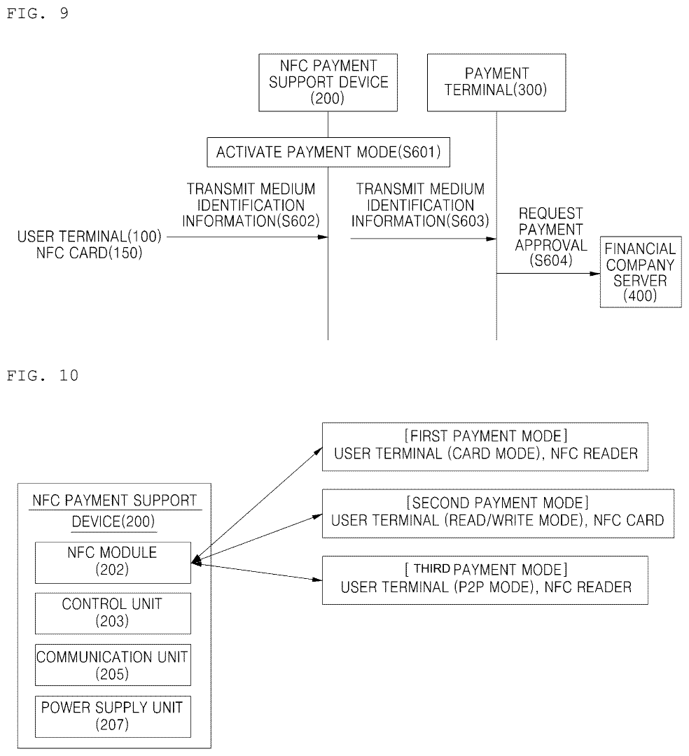

FIG. 9 illustrates a fifth embodiment of the present disclosure. In the fifth embodiment, a configuration of a system that allows general consumers to perform payment based on NFC technology, regardless of NFC modes supported by user terminals 100 of the general users or NFC modes set by the user terminals 100 is shown.

Referring to FIG. 9, a consumer may bring the user terminal 100 or an NFC card 150 to access an NFC payment support device 200 for multi modes and transmit, to the multi-mode NFC payment support device 200, information needed for payment, particularly, information for identifying a payment medium (a card number, or a one-time code capable of replacing the card number, hereinafter referred to as medium identification information). The ‘transmitting of information’ means that medium identification information needed for NFC payment is read or recorded by the NFC payment support device 200 using any element or method, and may indicate that the NFC payment support device 200 is placed in a state of being capable of subsequently transmitting the medium identification information to the payment terminal 300. Meanwhile, the medium identification information described herein may be transmitted to the financial company server 400 with additional information needed for payment added by the payment terminal 300. The financial company server 400 may determine whether to approve payment based on information received from the payment terminal 300.

For reference, the user terminal 100 described herein may attempt to perform payment when an NFC mode is set to a read/write mode, or may attempt to perform payment when an NFC mode is set to a card emulation mode. A payment mode of the NFC payment support device 200 may be changed or activated according to an NFC mode of the user terminal 100 to perform payment according to the NFC mode, as is to be described in detail later. For reference, the payment terminal 300 is not necessarily limited to a terminal that performs payment, but may also be referred to as a device configured to function as an intermediary for receiving medium identification information from the NFC payment support device 200 and transmitting the medium identification information to another external device, i.e., a host device in a broad sense.

Referring back to FIG. 9, the multi-mode NFC payment support method may include activating, by the NFC payment support device 200, a particular payment mode (S601). Then, the NFC payment support device 200 may receive medium identification information, i.e., card information from a user terminal or an NFC card according to the activated payment mode (S602).

The payment mode may mean a payment environment that may be changed by the NFC payment support device 200 by setting a mode of an NFC module inside the NFC payment support device 200 to perform payment based on NFC technology. The NFC payment support device 200 according to the present disclosure may support at least two payment modes. A plurality of payment modes may include, for example, a first payment mode in which medium identification information may be received from the user terminal 100 or the NFC card 150 set to a card mode (a card emulation mode), a second payment mode in which medium identification information may be received from the user terminal 100 in a read/write mode, and a third payment mode in which medium identification information may be received from the user terminal 100 set to a peer-to-peer mode. To help understanding of the present disclosure, a case when a consumer makes a payment while holding a smartphone (a user terminal) is further described as an example. In this case, the first payment mode is a state in which the NFC payment support device 200 is activated in a read/write mode. At this time, medium identification information (card information) may be read by the NFC payment support device 200 when the user terminal 100 is set to a card mode. The second payment mode is a state in which the NFC payment support device 200 is activated in a tag emulation mode. At this time, the user terminal 100 may write medium identification information (card information) to the NFC payment support device 200 while being set to a read/write mode. In the third payment mode, the user terminal 100 may share medium identification information (card information) with the NFC payment support device 200 when both the NFC payment support device 200 and the user terminal 100 are set to a peer-to-peer mode.

Media identification information may include a particular medium needed to perform payment, e.g., card information (a card number), a one-time value (a code), or other unique values (codes). As a simple example, when a payment application is executed on the user terminal 100 to perform payment, a one-time code (a barcode, a QR code, etc.) with a limited time may be displayed on a screen. The one-time code generated using this method may be a type of medium identification information. Meanwhile, the medium identification information in the present disclosure may not be displayed in a form of a barcode or QR code as described above, i.e., in a form displayed on a screen. Only a message indicating that NFC payment is ready or a message requesting to perform NFC payment may be displayed on a screen of the user terminal 100.

Meanwhile, after operation S602, the NFC payment support device 200 may transmit the medium identification information to the payment terminal 300 (S603). For reference, operation S603 may be performed immediately after operation S602. The payment terminal 300 may immediately receive the medium identification information without performing prior preparation such as separately transmitting a ready state to the NFC payment support device 200.

After operation S603, the payment terminal 300 may transmit the received medium identification information together with payment information generated by the payment terminal 300 to the financial company server 400 (S604). The payment information means information about a purchase when a user wants to purchase a product or service in a particular member store, and may include, for example, a price, quantity, a name, transaction date and time, a transaction location, a name of a person in charge who is involved in a transaction, or a name of a representative of a member store, with respect to a product or service to be transacted. In addition, although not illustrated, after operation S604, the financial company server 400 may approve the medium identification information received from the payment terminal 300, and approve payment. In addition, the financial company server 400 may transmit a result of the approval to at least one of the payment terminal 300 and the user terminal 100.

The NFC payment support method according to the present disclosure has been briefly and sequentially described with reference to FIG. 9.

FIG. 10 is a diagram illustrating components of the payment support device 200. Referring to FIG. 10, the payment support device 200 may largely include an NFC module 202, the control unit 203, the communication unit 205, and the power supply unit 207. These components are generally similar to those described above with reference to FIG. 3.

However, FIG. 10 shows the NFC module 202 separately to be distinguished from the NFC tag module 201 shown in FIG. 3. The NFC module 202 may be switched into and activated in two or more payment modes, and configured to have medium identification information written thereto or read medium identification information from a user terminal or an NFC card according to an activated payment mode. The NFC module 202 may further include a loop line to receive power as needed. FIG. 10 illustrates an environment in which the NFC module 202 supports an NFC payment method together with a user terminal, an NFC reader, or an NFC card. For example, the NFC module 202 may be activated in a read/write mode to operate in the first payment mode by the user terminal 100 or an NFC card set to a card mode (a card emulation mode), or the NFC module 202 may be activated in a tag emulation mode to operate in the second payment mode by the user terminal 100 or an NFC reader set to a read/write mode, or the NFC module 202 may be activated in a P2P mode to operate in the third payment mode by the user terminal 100 or an NFC reader set to the P2P mode.

A description about the control unit 203, the communication unit 205, and the power supply unit 207 will not be provided here again to avoid repeated description.

The components of the payment support device 200 used in the fifth embodiment have been described above with reference to FIG. 10.

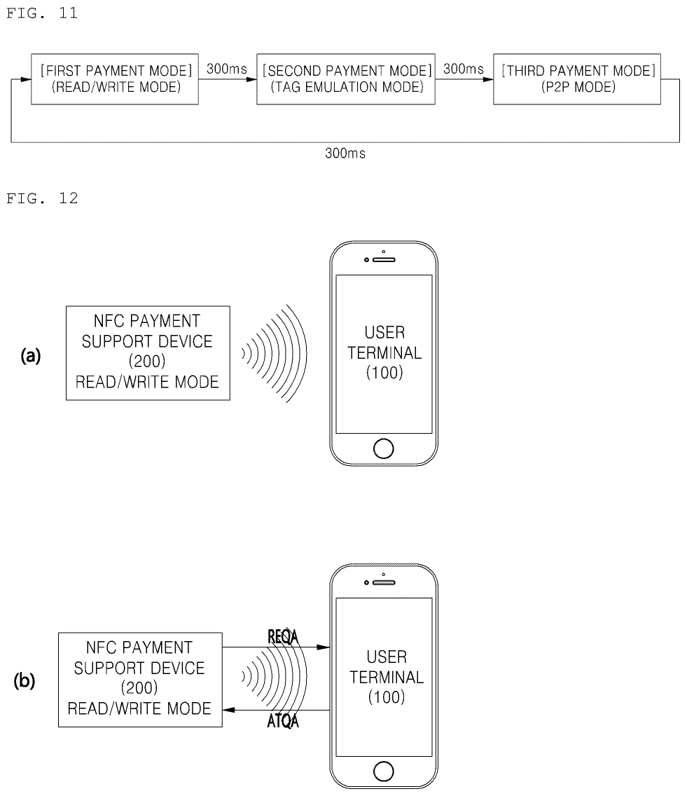

FIG. 11 is a diagram for explaining a payment support method according to a fifth-first embodiment of the present disclosure. With reference to FIG. 9, the activating of one payment mode among a plurality of payment modes by the payment support device 200 (S601) has been described above. In the fifth-first embodiment, the payment support device 200 may repeatedly or cyclically activate the plurality of payment modes one by one for a preset time period or at a preset interval. Referring to the drawing, it may be checked that payment modes of the payment support device 200 are repeatedly activated, e.g., in an order from the first payment mode (a read/write mode)—the second payment mode (tag emulation mode)—the third payment mode (a P2P mode) to the first payment mode (read/write mode)— . . . . At this time, each payment mode may be controlled by the control unit 203 so that a next payment mode is activated at an interval of set time, for example, every 300 ms.

When the fifth-first embodiment is actually implemented, the payment support device 200 may activate the plurality of payment modes at a very short interval to perform NFC payment in an appropriate payment mode during an access by a user terminal 100 or an NFC card of a consumer. For example, when the user terminal 100 is in a card mode, the payment support device 200 may receive medium identification information in a state of being in proximity to the user terminal 100 at a short moment (300 ms) when the first payment mode is activated. Likewise, when the user terminal 100 is in a read/write mode or when the user terminal 100 is in the P2P mode, the payment support device 200 may receive medium identification information during a time period when being activated in the second payment mode or the third payment mode. Resultantly, the payment support device 200 may perform NFC payment regardless of a type of an NFC payment element held by a consumer.

Meanwhile, in the above example, time or an interval for which a payment mode is activated is described as 300 ms to help understanding of the present disclosure. However, the present disclosure is not limited thereto, and it may be understood that the time or the interval described above may be determined according to an intention of a designer or an operator. However, considering a situation of payment between an owner of a member store and a consumer, it may cause inconvenience for the consumer to bring a smartphone close to the payment support device 200 for an excessively long period of time. Thus, it may be desirable to ensure that one cycle of all payment modes may be performed within less than 1 second as possible.

In the fifth-first embodiment, the payment support device 200 may be designed to initially cyclically activate payment modes according to a preset time or interval when an access of an NFC payment element from a consumer is not present, and maintain an activation state of a particular payment mode for a constant time at a moment when an access of an NFC payment element is detected. For example, the payment support device 200 may be designed to, when an activation state has changed from the first payment mode to the second payment mode upon access of the user terminal 100 in a read/write mode, receive medium identification information from the user terminal 100 (more precisely, performing a process of writing the medium identification information to the NFC module 210 by the user terminal 100 and reading the medium identification information by the payment support device 200) and, when the reception of the medium identification information is detected, maintain a same payment mode for a longer time, e.g., up to 5 seconds.

Conversely, the payment support device 200 may be designed to continue to perform a cycle of repeating payment modes without stopping even when receiving of particular medium identification information is detected upon access by an NFC payment element from a consumer. Particularly, in payment modes in which medium identification information is read from the user terminal 100 in a card mode (the first payment mode) or medium identification information is read after being written to the NFC module 202 (the second payment mode), a process of receiving medium identification information is performed in a very short time. Thus, NFC payment may be performed normally even when a cycle of repeating the payment modes is not stopped for certain time.

Meanwhile, by applying the payment support method according to the first embodiment, a plurality of NFC payments may be processed within almost same time when several NFC payment elements are in close proximity. For example, assuming that two consumers split the bill after eating together, when a first smartphone in a card mode and a second smartphone in a read/write mode are brought in proximity to the payment support device 200 at the same time, NFC payments for the first smartphone and the second smartphone may be performed sequentially according to a cycle of repeating payment modes in the payment support device 200. Since medium identification information from each smartphone is read or written during in a very short time less than one second, consumers may have an experience as if two payments are processed almost simultaneously.

The NFC payment support method according to the fifth-first embodiment has been described with reference to FIG. 11.

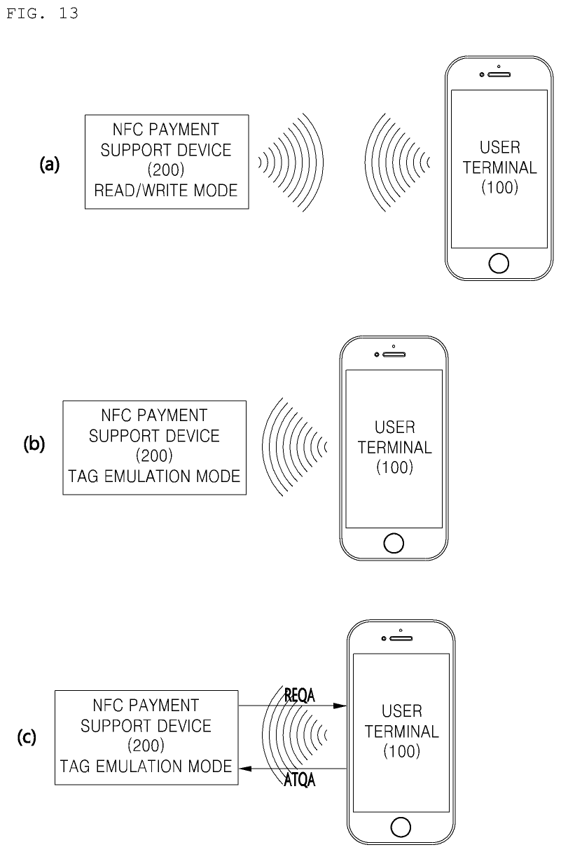

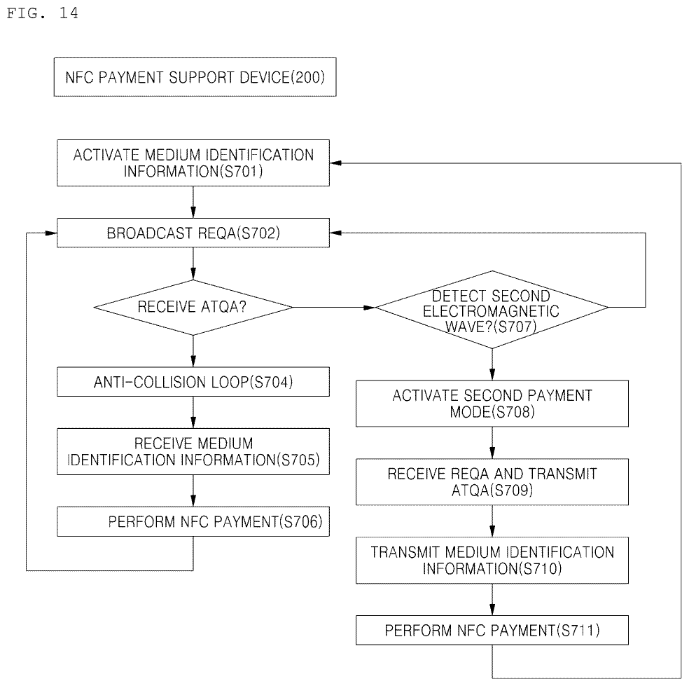

FIGS. 12 and 13 are drawings for explaining a payment support method according to a fifth-second embodiment. In the fifth-second embodiment, the payment support device 200 may generate an electromagnetic wave, and in this state, when an access of an NFC payment element is detected, a payment mode matching the NFC payment element may be activated.

Referring to FIG. 12, the payment support device 200 may be controlled to generate and emit an electromagnetic wave to outside in a state of being initially set to a read/write mode. A card recognition signal REQA may be continuously broadcast via the electromagnetic wave. At this time, when the user terminal 100 or an NFC card set to a card mode accesses the payment support device 200, the payment support device 200 may receive a response signal ATQA in response to the card recognition signal REQA. When the response signal ATQA is received, medium identification information of the user terminal 100 or the NFC card may be received in the read/write mode to perform NFC payment.

Referring to FIG. 13, the payment support device 200 may also generate and emit an electromagnetic wave to outside in a state of being initially set to a read/write mode. At this time, when the user terminal 100 or an NFC reader set to a read/write mode accesses the payment support device 200, the payment support device 200 may detect another electromagnetic wave generated from the user terminal 100 or the NFC reader (electromagnetic waves being distinguished into a first electromagnetic wave generated from the payment support device 200, and a second electromagnetic wave generated from the user terminal or the NFC reader). When the second electromagnetic wave is detected, the payment support device 200 may immediately convert the NFC module 202 to a tag emulation mode. In other words, the payment support device 200 may activate the second payment mode so that the medium identification information may be written by the user terminal 100 or the NFC reader, and then, read. For reference, the second electromagnetic wave generated by the user terminal or the NFC reader may be an electromagnetic wave of a particular frequency (13.56 MHz) generated and emitted to prevent a collision with other equipment.

After the second payment mode is activated, the payment support device 200 may receive a card recognition signal REQA from the user terminal 100 or the NFC reader, and transmit a response signal ATQA in response thereto. Then, NFC payment may be performed according to a subsequent protocol.

FIG. 14 is a flowchart illustrating the fifth-second embodiment described above. Referring to the drawing, the fifth-second embodiment may first include setting the payment support device 200 to a read/write mode, in other words, activating the payment support device 200 in the first payment mode (S701).

After operation S701, the payment support device 200 may generate an electromagnetic wave (the first electromagnetic wave) and broadcast a card recognition signal REQA to outside through the electromagnetic wave (S702). The card recognition signal REQA is a type of signal used to detect an access of any external NFC payment element, and particularly, may be a signal for inducing a response signal ATQA to be transmitted when a user terminal or NFC card in the card mode responds to the electromagnetic wave.

After operation S702, the payment support device 200 checks whether the response signal ATQA has been received (S703). When the response signal ATQA has been received, the payment support device 200 executes an anti-collision loop (S704), and then, reads medium identification information (e.g., UID, SAK, etc.) of the user terminal or the NFC card (S705), and performs NFC payment according to a defined protocol (S706).

Meanwhile, when the response signal ATQA is not received in operation S703, the payment support device 200 may check whether a second electromagnetic wave is detected from another user terminal or NFC reader (S707). When a second electromagnetic wave is not detected, the payment support device 200 returns to operation S702 to generate the first electromagnetic wave and broadcast the card recognition signal REQA.

Conversely, when a second electromagnetic wave is detected in operation S707, the payment support device 200 may switch the NFC module 202 to a tag emulation mode or activate the second payment mode (S708). Then, the payment support device 200 may receive a card recognition signal REQA from a user terminal or an NFC reader emitting the second electromagnetic wave and transmit a response signal ATQA (S709).

After operation S709, medium identification information (UID, SAK, etc.) may be transmitted to the user terminal or the NFC reader emitting the second electromagnetic wave (S710) and NFC payment may be performed (S711).

An NFC payment support method and an NFC payment support device needed to perform the same have been described above. The present disclosure is not limited to the particular embodiments and application examples described above, and various changes and modifications thereof may be made by those skilled in the art without departing from the essence of the disclosure as claimed in the claims. Such changes and modifications should not be understood as being separate from the technical idea or viewpoint of the present disclosure.

DESCRIPTION OF SYMBOLS

| | |
|---|---|
| 100 User terminal | 200 NFC payment support device |
| 250 NFC support device | 300 Payment terminal |
| 320 NFC payment terminal | 400 Financial company server |

1. A method of supporting near field communication (NFC) payment for a user terminal, the method comprising:
writing medium identification information from the user terminal to an NFC tag module in an NFC payment support device;
reading, by the NFC payment support device, a value written to the NFC tag module; and
transmitting, by the NFC payment support device, the read value to a payment terminal.

2. The method of claim 1, wherein the medium identification information written to the NFC payment support device is medium identification information encrypted by the user terminal.

3. The method of claim 2, further comprising, after the writing of the encrypted medium identification information to the NFC payment support device,
decrypting, by the NFC payment support device, the encrypted medium identification information; and
determining, by the NFC payment support device, whether the decrypted medium identification information is medium identification information for NFC payment.

4. A near field communication (NFC) payment support device configured to support NFC payment for a user terminal, the NFC payment support device comprising:
an NFC tag module to which medium identification information from the user terminal is written by an NFC writing function of the user terminal;
a control unit configured to read a value written to the NFC tag module and transmit the read value to a payment terminal via a port;
a communication unit configured to support transception of data between the NFC payment support device and the payment terminal connected to the NFC payment support device via a network; and
a power supply unit configured to supply power for driving the NFC payment support device.

5. The NFC payment support device of claim 4, further comprising a microphone configured to detect a sound wave signal output from the user terminal,
wherein the control unit converts the sound wave signal detected by the microphone into a signal transmittable to the payment terminal.

6-10. (canceled)
